(19) United States
(12) Patent Application Publication
(10) Pub. No.: US 2002/0048497 A1
(43) Pub. Date: Apr. 25, 2002

(54) Attachment device for elongate objects

(76) Inventor: Armin Herb, Apfeldorf (DE)

Correspondence Address: SIDLEY AUSTIN BROWN & WOOD LLP, 875 Third Avenue, New York, NY, 10022, US

(21) Appl. No.: 09/981,502

(22) Filed: Oct. 17, 2001

(30) Foreign Application Priority Data
Oct. 23, 2000 (DE) 100 52 547.4

(51) Int. Cl. F16B 27/00

(52) U.S. Cl. 411/85

(57) ABSTRACT

An attachment device including an anchoring unit having at least two gripping members (9, 22, 37) and a receiving member (10, 26, 35) with openings (14, 28, 36) for guiding the gripping members (9, 22, 37), a mounting rail (2, 20) with a mounting opening (3) limited on its opposite sides by longitudinal walls (4), with the longitudinal walls (4) being provided on its adjacent to each other sides with retaining projections (5, 21, 40) that are engaged, in a locking position of the device, at least partially by corresponding gripping members (9, 22, 37) in a directions transverse to a longitudinal direction of the mounting rail (2); and a bolt (7, 33) for connecting an attachable object to the anchoring unit (1).

### BACKGROUND OF INVENTION

1. Field of the Invention

The present invention relates to an attachment device for elongate objects and including an anchoring unit having at least two, movable relative to each other and preloaded against each other, gripping members, a mounting rail with a mounting opening limited on its opposite sides by longitudinal walls, the longitudinal walls being provided on their adjacent to each other sides with retaining projections that are engaged, in a locking position of the device, at least partially by corresponding gripping members in a direction transverse to a longitudinal direction of the mounting rail, and a bolt for connecting an attachable object to the anchoring unit.

2. Description of the Prior Art

Attachment devices of a type described above serve, e.g., for attachment objects to constructional components with the use of a mounting rail. E.g., the attachment device can be used for suspending objects such as tubular conduits or the like.

European Publication EP-671581 B1 discloses, e.g., an attachment device of the type described above with the gripping members engaging the retaining projections from behind. The gripping member is formed of two, elastically preloaded with respect to each other, support elements engaging the corresponding retaining projections. A bolt connects the gripping member with a stop that engages free, longitudinal edges of the mounting rail. The retaining projections are clamped to the stop by tightening of the gripping member to the stop.

The advantage of the device disclosed in EP-671581 B1 consists in that the support elements can be preliminary locked into place in the mounting rail, preventing the anchoring unit from falling out. This advantage proved to be particularly useful at an overhead mounting.

The drawback of the device disclosed in EP-671581 B1 consists in the instability of the gripping member. On one hand, this drawback results in an inaccurate guidance of the anchoring part when it is introduced into the mounting rail. On the other hand, this drawback results in that the attachment device can be used only for low load values.

Accordingly, an object of the present invention is to provide an attachment device of the above-described type capable to withstand high loan values.

Another object of the present invention is to provide an attachment device of the type described above which can be easily handled.

A further object of the present invention is to provide an attachment device of the type described above and which can be economically produced.

### SUMMARY OF THE INVENTION

These and other objects of the present invention, which will be come apparent hereinafter, are achieved by providing a receiving member with openings which insure an optimal guidance of the gripping members which engage the retaining projections.

Advantageously, the receiving member has at least two, extending in a longitudinal direction anchoring walls having, in a locking position of the device, at least two respective engagement points with the corresponding retaining projections. The engagement of the anchoring walls with the retaining projections prevents rotation of the receiving member and of the entire anchoring unit relative to the mounting rail. Generally, the receiving member is so formed that at least four engagement points of the anchoring walls with the retaining projections are provided. The engagement points also insure that the anchoring unit would occupy a predetermined position upon being introduced into the mounting opening in the mounting rail.

Preferably, the anchoring walls extend parallel to the retaining projections, abutting the retaining projection in the locking position of the attachment device. With the anchoring walls extending parallel to the retaining projection, a maximal guiding surface for the anchoring unit is provided, on one hand, and, on the other hand, an optimal distribution of forces along the anchoring unit is insured when the force vector is inclined with respect to the anchoring unit.

Advantageously, the receiving member is formed as a U-shaped member, with the legs of the U-shaped profile forming the anchoring walls. This insures uniform distribution of forces, which are produced upon application of a load, over the mounting rail. This shape of the receiving member also insures its economical manufacture and easy assembly of the attachment device.

In order to insure a hinged positioning of the gripping members, they are formed as a L-shaped members and have each, at its end opposite a retaining projection-engaging end, a web engaging in a complementary recess formed in the receiving member. The simple shape of the gripping members insure their economical manufacture. Naturally, other ways of positioning of the gripping members can be used. The gripping members can be formed as a one-piece part of a spring steel. Advantageously, the gripping element have two-three gripping fingers engaging the retaining projections.

In accordance with another advantageous embodiment of the present invention, the gripping members cross each other about a rotatable axle that pivotally connects the two gripping members. The attachment device further includes a torsional spring which is supported on the rotatable axle and biases, in the locking position of the device, the two gripping members against each other and toward the retaining projections. This arrangement of the gripping members provides for a particularly high stability.

Preferably, the gripping members have, at least in the regions that engage the retaining projections, a V-shaped cross-section. This shape of the engaging regions of the gripping members insures a reduced consumption of material, which also reduces their weight, and an optimal stability of the gripping members. To insure easy snapping of the gripping elements behind the retaining projections when the anchoring unit is introduced into the mounting opening, the engaging region of the gripping elements are provided each with a guide ramp. When the anchoring unit is introduced into the mounting opening, the gripping members slide along the ramps relative to each other, only snapping behind the retaining projections.

Preferably, the anchoring unit has a stop engaging one of the free longitudinal edges of the mounting rail. The use of a stop is particularly important when the to-be-attached object cannot perform the function of a stop. The stop can be formed, e.g., as a plate projecting partially past the rail.

According to the present invention, the connection bolt has, at least along a portion of its longitudinal extent, an outer thread and has, at its end remote from the anchoring unit, a torque transmitting element projecting radially beyond the bolt. The bolt insures an easy mounting of a to-be-attached object with the attachment device on a constructional component. As a torque transmitting element, can, e.g., a polygonal bolt head be used. The to-be-attached object can have, e.g., a bore the diameter of which substantially corresponds to the outer diameter of the bolt. The torque-transmitting element insures that the object is pressed against the mounting rail.

The receiving member has preferably an inner thread for connection of the anchoring unit with the bolt. The inner thread provides for an economical and convenient connection.

The novel features of the present invention, which are considered as characteristic for the invention, are set forth in the appended claims. The invention itself, however, both as to is construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional view of a first embodiment of an attachment device in a non-operative position thereof;

FIG. 2 a cross-sectional view of the attachment device shown in FIG. 1 in its operative position;

FIG. 3 a longitudinal elevational view of the attachment device shown in FIGS. 1-2;

FIG. 4 a cross-sectional view of a second embodiment of an attachment device according to the present invention that is formed as an angular attachment device for connecting two mounting rails;

FIG. 5 a cross-sectional view of the attachment device shown in FIG. 4 but pivoted by 90°;

FIG. 6 a cross-sectional view of a third embodiment of an attachment device according to the present invention with crossed gripping members in an on-operative position;

FIG. 7 a cross-sectional view of the device shown in FIG. 6 in its operative position; and'

FIG. 8 a front view of the gripping member of the attachment device shown in FIGS. 6-7.

### DETAILED DESCRIPTION OF THE PREFERRED EMBODIMENTS

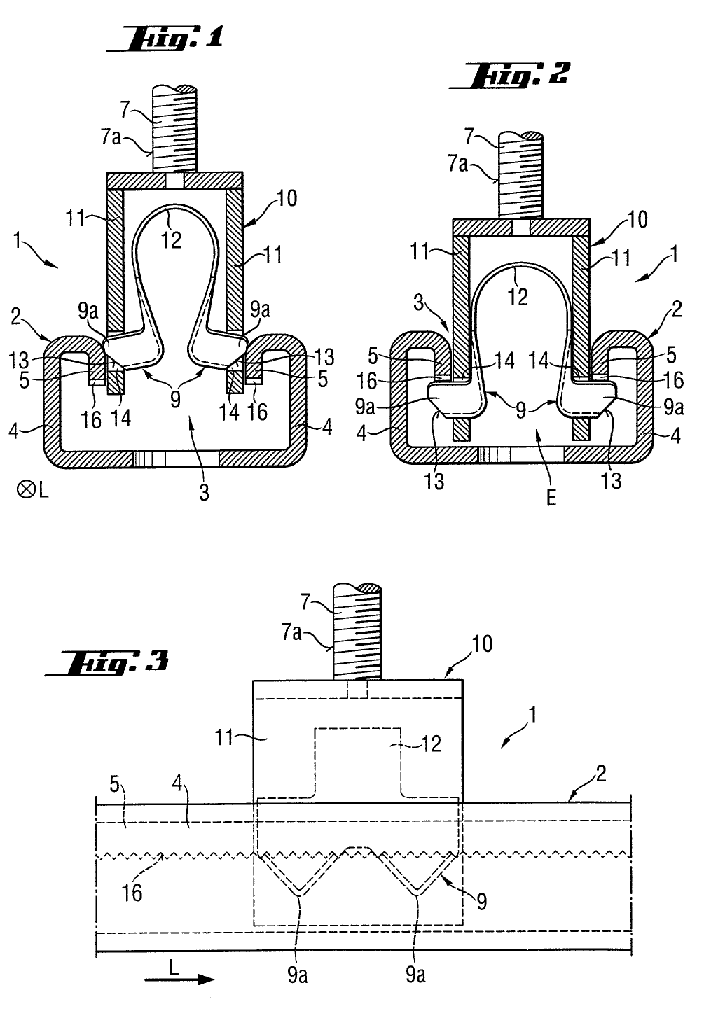

A first embodiment of an attachment device according to the present invention, which is shown i FIGS. 1-3, includes an anchoring unit 1 having at least two, movable relative to each other and preloaded against each other, gripping members 9. The anchoring unit 1 further includes a mounting rail 2 having a mounting opening 3 limited, on its opposite sides, by longitudinal walls 4. The longitudinal walls 4 have, on their adjacent inner sides, retaining projections 5. The retaining projections 5 are engaged from behind, in the locking position E, shown in FIG. 2, at least partially by respective gripping members 9 of the anchoring unit 1 in a direction transverse to the longitudinal direction L of the mounting rail 2.

For securing an object (not shown), the anchoring unit 1 has a bolt 7 with an outer thread 7a which is connected with a receiving member 10 having a plurality of openings 14 through which the gripping members 9 are extendable. The receiving member 10 has a U-shaped cross-section with the legs being formed by two anchoring walls 11 which extend parallel to the retaining projections 5 and abut the same in the locking position E.

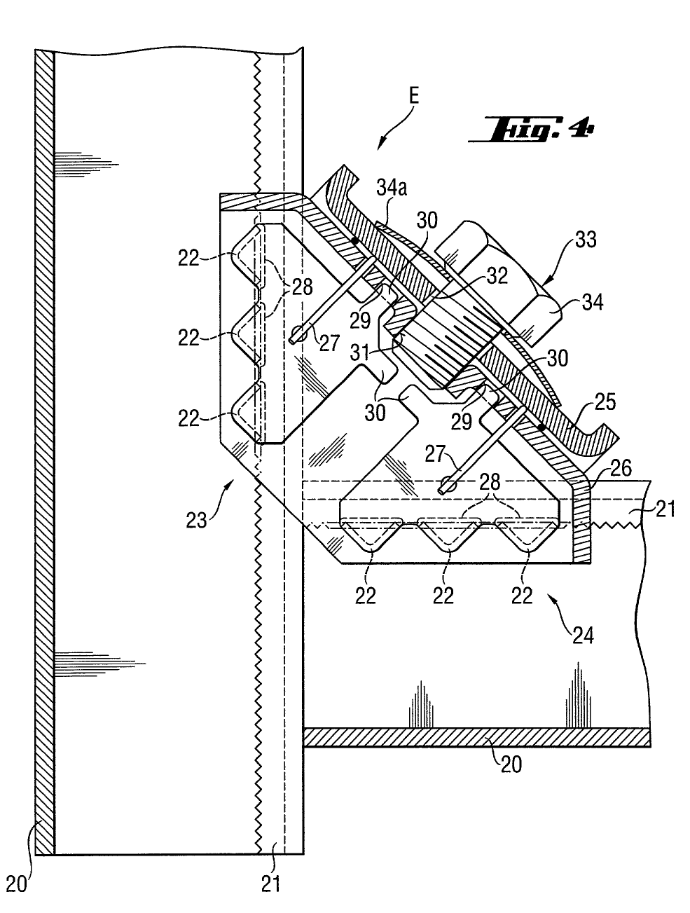

The gripping members 9 are L-shaped and are connected with each other by a U-shaped spring stirrup 12. To insure an easy insertion of the receiving member 10 into the mounting opening 3, the gripping members 9 have each a guide ramp 13. The gripping member 9 has, in the region of its gripping finger 9a, a V-shape, as particularly shown in FIG. 3. The V-shaped formation increases stiffness of the gripping member 9 and, in particular, of its gripping finger 9a, on one hand, and, on the other hand, the V-shaped formation provides edges that cooperate with a mating toothing 16 provided on the retaining projections 5.

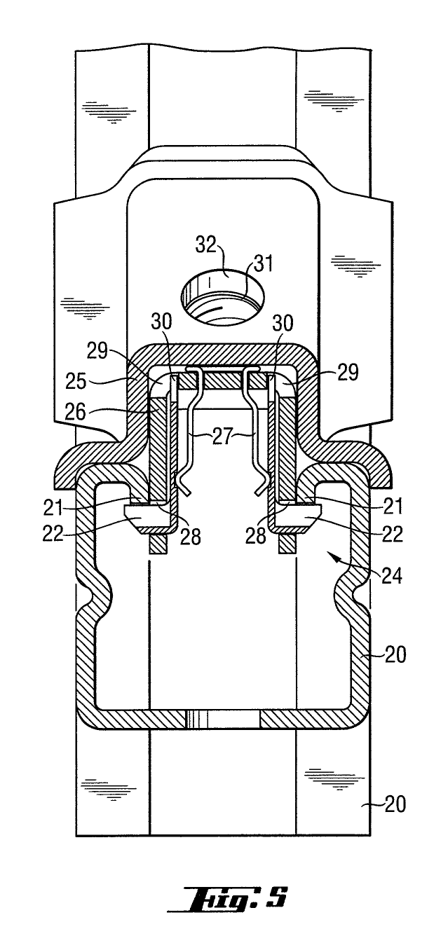

Another embodiment of the attachment device according to the present invention, which is shown in FIGS. 4-5, includes a mounting rail 20 provided with retaining projections 21 which are engaged from behind by gripping members 22 in the locking position E. The attachment device, which is shown in FIGS. 4-5, is formed as an angular attachment device. The device includes two anchoring units 23, 24 connected with each other by an angular element 25. The gripping members 22 are preloaded against each other by a spring member 27, as particularly shown in FIG. 5. The gripping members 22 are guided by a receiving member 26. The gripping members 22 extend through openings 28 in the receiving member 26 and extend with their webs 30 in the recesses 29 in the receiving member 26. The foregoing elements provide for a hinged connection of the gripping members 22 with the receiving member 26. The receiving member 26 has further an inner thread 31 on its side adjacent to the angular element 25.

The angular element 25 has a through-bore 32 for receiving a bolt 33 with a head 34. The bolt 33 has an outer thread corresponding to the inner thread 31 of the receiving member 26. The bolt head 34 serves as a torque transmitting element for securing the inventive attachment device. For a preliminary attachment, a spring member 34a is provided between the head 34 and the angular element 25.

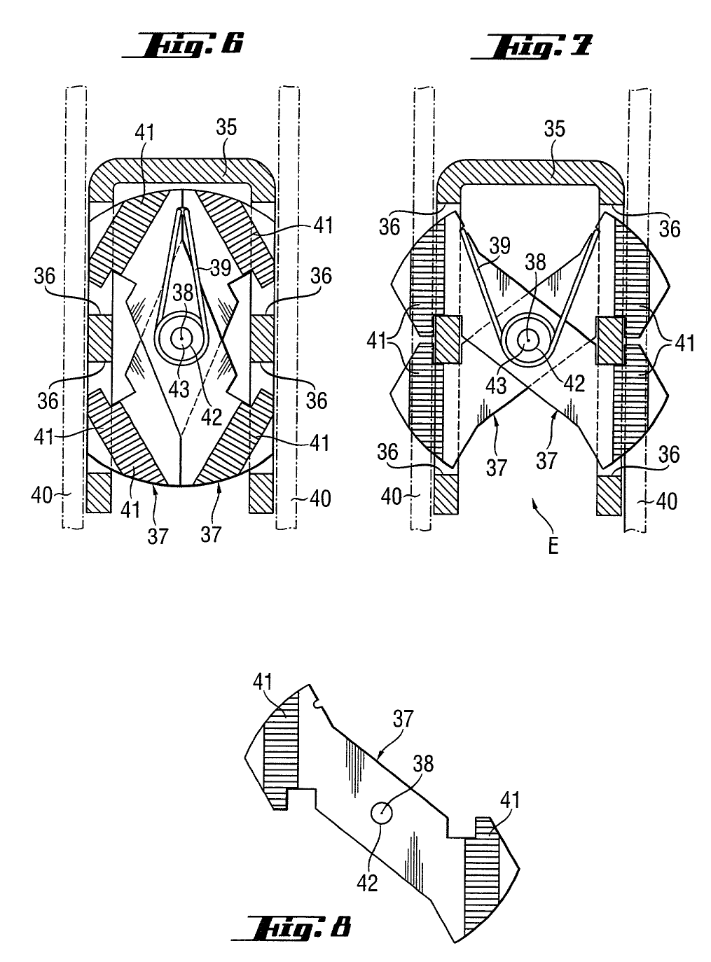

A third embodiment of the attachment device according to the present invention which is shown in FIGS. 6-8, includes a receiving member 35 and two gripping members 37 extending through the openings 36 formed in the receiving member 35. The two gripping members 37 cross each other about a common axle 38 about which the gripping members 37 pivot relative to each other. A torsional spring 39, which is supported on the axle 38, preload the gripping members 37 against each other in the direction of retaining projections 40, as shown in FIG. 7.

FIG. 8 shows the gripping member 37 having toothing 41 in its region that engages the retaining projection 40. In the locking position E, the region with the toothing 41 engages from behind the retaining projection 40. The toothing 40 increases the holding value of the attachment device as the toothing 41 increases friction between the retaining projection 40 and the gripping member 37. In its center, the gripping member 37 has a through-opening 42 through which a bolt 43, which is secured on the receiving member 35, extends.

Though the present invention was shown and described with references to the preferred embodiments, such are merely illustrative of the present invention and are not be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. An attachment device, comprising an anchoring unit (1) having at least two, movable relative to each other and preloaded against each other, gripping member (9, 22, 37) and a receiving member (10, 26, 35) with openings (14, 28, 36) for guiding the gripping members (9, 22, 37); a mounting rail (2, 20) with a mounting opening (3) limited on opposite sides thereof by longitudinal walls (4), the longitudinal walls (4) being provided on adjacent to each other sides thereof with retaining projections (5, 21, 40) that are engaged, in a locking position of the device, at least partially, by corresponding gripping members (9, 22, 37) in a directions transverse to a longitudinal direction of the mounting rail (2); and a bolt (7, 33) for connecting an attachable object to the anchoring unit (1).

2. An attachment device according to claim 1, wherein the receiving member (10, 26, 35) has at least two, extending in a longitudinal direction (L) anchoring walls (11) which have, in a locking position (E) of the device at least two respective engagement points with the corresponding retaining projections (5, 21, 40).

3. An attachment device according to claim 2, wherein the anchoring walls (11) extend parallel to the retaining projections (5, 21, 40) and substantially abut same in the locking position (E).

4. An attachment device according to claim 2, wherein the receiving member (10, 26, 35) is formed as a U-shaped member, and free legs of the U-shaped member form the anchoring walls (11).

5. An attachment device according to claim 1, wherein the gripping member (22) is formed as a L-shaped member and have, at an end thereof opposite a retaining projection-engaging end, a web (30) engaging in a complementary recess (29) formed in the receiving member (26).

6. An attachment device according to claim 1, wherein the gripping members (37) cross each other about a rotatable axle (43) that pivotally connects the two gripping members, and wherein the attachment device further comprises a torsional spring (39) which is supported on the rotatable axle (43) and biases, in the locking position (E) of the device, the two gripping members (37) against each other and toward the retaining projections (40).

7. An attachment device according to claim 1, wherein the gripping members (9, 37) have, at least in regions that engage the retaining projections (5, 40), a V-shaped cross-section.

8. An attachment device according to claim 1, wherein the anchoring unit (1) has a stop engaging one of three longitudinal edges of the mounting rail (2).

9. An attachment device according to claim 1, wherein the bolt (7) has, at least along a portion of its longitudinal extent thereof, an outer thread (7a) and has, at an end thereof remote from the anchoring unit (1), a torque transmitting element (34) projecting radially beyond the bolt (7).

10. An attachment device according to claim 9, wherein the receiving member (10) has an inner thread (18) which cooperates with the outer thread (7a) of the bolt (7), providing for connection of the bolt (7) with the anchoring unit (1).
